(19) United States
(12) Patent Application Publication
(10) Pub. No.: US 2024/0426964 A1
(43) Pub. Date: Dec. 26, 2024

(54) PERCEPTION SHARING BETWEEN DEVICES

(71) Applicant: QUALCOMM Incorporated, San Diego, CA (US)

(72) Inventors: Simone MERLIN, San Diego, CA (US); Hussein METWALY SAAD, San Diego, CA (US); Yann LEBRUN, Velizy-Villacoublay (FR); Peerapol TINNAKORNSRISUPHAP, San Diego, CA (US); In-Soo KIM, San Diego, CA (US)

(21) Appl. No.: 18/340,595

(22) Filed: Jun. 23, 2023

(51) Int. Cl. G01S 5/02; G06T 7/70

(52) U.S. Cl. CPC G01S 5/0268; G06T 7/70

(57) ABSTRACT

Techniques for sharing perception information between a first device and a second device are disclosed. In some embodiments, the first device may be a user equipment (UE), and the second device may be a wearable device (e.g., smart glasses). An example method of sharing perception information may include obtaining one or more measurements indicative of a motion or a position of the first device; obtaining one or more measurements indicative of a motion or a position of the second device; and receiving perception information responsive to a verification that a condition relating to the first device and the second device is established, the verification of the condition being based on the one or more measurements indicative of the motion or the position of the first device and the one or more measurements indicative of the motion or the position of the second device.

### BACKGROUND

### 1. Field of Disclosure

The present disclosure relates generally to the field of wireless communications, and more specifically to data communication between wireless devices and optimization of wireless links.

### 2. Description of Related Art

Virtual reality (VR), augmented reality (AR), mixed reality (MR) (collectively “XR”) can process visual information to augment a user's perception of an environment or provide additional context to the environment. To do this, XR can obtain image data from the environment as well as persistent positioning and orientation of the associated wearable device (e.g., head-mounted display or smart glasses) relative to the environment, at least in part by perceiving the environment using at least one sensor (e.g., camera or radio frequency (RF) sensor).

### BRIEF SUMMARY

In one aspect of the present disclosure, a method is disclosed. In some embodiments, the method may be a method of sharing perception information between a first device and a second device, and may include: obtaining one or more measurements indicative of a motion or a position of the first device; obtaining one or more measurements indicative of a motion or a position of the second device; and receiving perception information responsive to a verification that a condition relating to the first device and the second device is established, the verification of the condition being based on the one or more measurements indicative of the motion or the position of the first device and the one or more measurements indicative of the motion or the position of the second device, the perception information including a type of environment of the second device, a position of the second device, an orientation of the second device, image data, or a combination thereof.

In another aspect of the present disclosure, an apparatus is disclosed. In some embodiments, the apparatus may include: one or more wireless communication interfaces; one or more sensors; one or more memory; and one or more processors coupled to the one or more wireless communication interfaces, the one or more sensors, and the one or more memory, and configured to: obtain one or more measurements indicative of a motion or a position of a first device; obtain one or more measurements indicative of a motion or a position of a second device; and receive perception information responsive to a verification that a condition relating to the first device and the second device is established, the verification of the condition being based on the one or more measurements indicative of the motion or the position of the first device and the one or more measurements indicative of the motion or the position of the second device, the perception information including a type of environment of the second device, a position of the second device, an orientation of the second device, image data, or a combination thereof.

In some embodiments, the apparatus may include: means for obtaining one or more measurements indicative of a motion or a position of a first device; means for obtaining one or more measurements indicative of a motion or a position of a second device; and means for receiving perception information responsive to a verification that a condition relating to the first device and the second device is established, the verification of the condition being based on the one or more measurements indicative of the motion or the position of the first device and the one or more measurements indicative of the motion or the position of the second device, the perception information including a type of environment of the second device, a position of the second device, an orientation of the second device, image data, or a combination thereof.

In some variants, the apparatus may include the first device or the second device; wherein the first device is a user equipment (UE), and the second device is a wearable device.

In another aspect of the present disclosure, a non-transitory computer-readable apparatus is disclosed. In some embodiments, the non-transitory computer-readable apparatus may include a storage medium, the storage medium including a plurality of instructions configured to, when executed by one or more processors, cause the one or more processors to: obtain one or more measurements indicative of a motion or a position of a first device; obtain one or more measurements indicative of a motion or a position of a second device; and receive perception information responsive to a verification that a condition relating to the first device and the second device is established, the verification of the condition being based on the one or more measurements indicative of the motion or the position of the first device and the one or more measurements indicative of the motion or the position of the second device, the perception information including a type of environment of the second device, a position of the second device, an orientation of the second device, image data, or a combination thereof.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a communication system, according to an embodiment.

FIG. 2 is a diagram of a 5th Generation (5G) New Radio (NR) communication system, illustrating an embodiment of a communication system (e.g., the communication system of FIG. 1) implemented within a 5G NR communication network.

FIG. 3 is a diagram showing an example of how beamforming may be performed, according to some embodiments.

FIG. 4 is a diagram showing communications that can occur among a user equipment (UE), a wearable device, and a network entity, according to some embodiments.

FIG. 5 is a diagram showing an example of using inertial measurements at the UE and the wearable device to verify a condition for perception sharing, according to some embodiments.

FIG. 6 is an example diagram of a call flow showing signals exchanged between a wearable device and a UE to allow perception sharing, according to some embodiments.

FIG. 7 is a flow diagram of a method of sharing perception information between a UE and a wearable device, according to some embodiments.

FIG. 8 is a block diagram of an embodiment of a UE, which can be utilized in embodiments as described herein.

FIG. 9 is a block diagram of an embodiment of a computerized system, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi®) technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

Further, unless otherwise specified, the term “positioning” as used herein may absolute location determination, relative location determination, ranging, or a combination thereof. Such positioning may include and/or be based on timing, angular, phase, or power measurements, or a combination thereof (which may include RF sensing measurements) for the purpose of location or sensing services.

Various aspects relate generally to wireless communication and more particularly to device-to-device communication. Example devices in communication may include a first device and a second device, where the first device may be a user equipment (UE) such as a phone or a laptop, and the second device may be a wearable device such as a head-mounted display (HMD), heads-up display (HUD) (e.g., in smart glasses), augmented reality (AR) glasses, a smartwatch or wristband, a smart ring, and so on. Some aspects more specifically relate to sharing perception between any of the above devices. Perception by a device (e.g., via a camera of the wearable device) may be represented as environment information such as the type of environment (e.g., indoor or outdoor), a position within the environment, and/or a pose or orientation of the wearable device. Perception may refer to obtaining visual, optical, RF, or other sensed information about an environment in which a device is positioned and information about objects and features within that environment, which may also include information about or information enabling persistent positioning and orientation within an environment, contextual information and awareness, and environment reconstruction (e.g., in two or three dimensions). In some examples, a wearable device may share perception information collected via its sensors (e.g., images, videos) with a UE or smart wristband, upon verifying that a condition has been met. Such a condition may be a positional relationship between the wearable device and the UE, e.g., detecting that the wearable device and the UE are carried by the same user or a vehicle, or relative position and/or pose of the wearable device and the UE of varying precision. In some implementations, this can be done by determining a correlation between inertial or motion-based measurements of the wearable device and similar measurements of the UE. Different types or levels of conditions may be verified depending on the perception information to be shared. Sharing the perception information can allow enhanced downstream applications, e.g., such as switching the UE to a more appropriate network (e.g., Wi-Fi vs. cellular), optimizing connections to access points, or optimizing beamforming.

Particular aspects of the subject matter described in this disclosure can be implemented to realize one or more of the following potential advantages. In some examples, sharing perception information only if the condition is verified can ensure that the shared information will be relevant, appropriate, and usable for downstream applications at the receiving device, and thereby avoid wasting power or communication resources at both devices. Further, by requiring different level of conditions to be cleared depending on the coarseness or fineness of the perception information to be shared between the wearable device and the UE, these devices can better ensure that the type of perception information to be shared can be used effectively based on the application. In other examples, by sharing perception between the devices, the described techniques can be used to enhance downstream applications such as by optimizing wireless communication links by, e.g., reducing the “stickiness” when moving from venue to venue (e.g., moving away from indoor Wi-Fi access point to outdoor base station), selecting an access point having better connectivity, or beamforming with a base station having better connectivity).

Additional details will follow after an initial description of relevant systems and technologies.

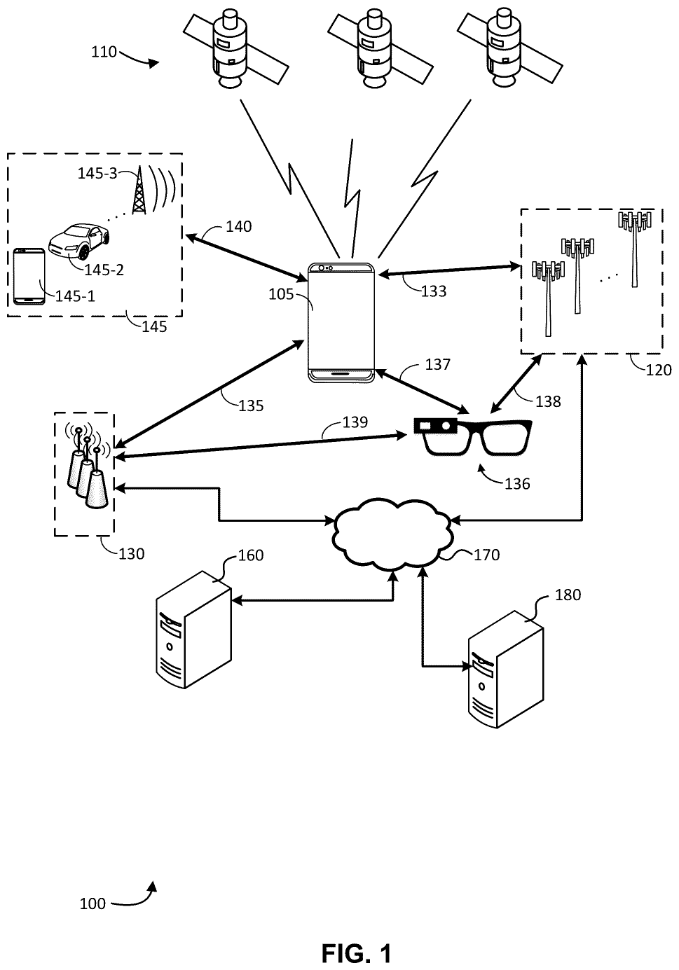

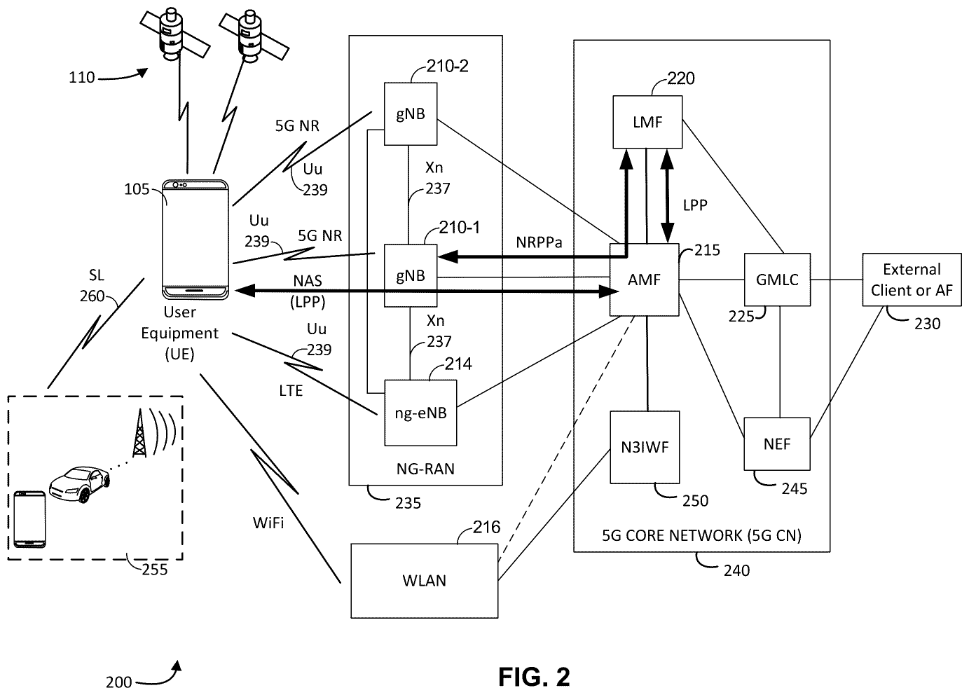

FIG. 1 is a simplified illustration of a communication system 100 in which a UE 105, location server 160, and/or other components of the communication system 100 can use the techniques provided herein for sharing perception information between UE 105 and a wearable device 136, according to an embodiment. The techniques described herein may be implemented by one or more components of the communication system 100. The communication system 100 can include: a UE 105; one or more satellites 110 (also referred to as space vehicles (SVs)), which may include Global Navigation Satellite System (GNSS) satellites (e.g., satellites of the Global Positioning System (GPS), GLONASS, Galileo, Beidou, etc.) and/or Non-Terrestrial Network (NTN) satellites; base stations 120; access points (APs) 130; location server 160; network 170; and external client 180. Generally put, the communication system 100 can estimate a location of the UE 105 based on RF signals received by and/or sent from the UE 105 and known locations of other components (e.g., GNSS satellites 110, base stations 120, APs 130) transmitting and/or receiving the RF signals. Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the communication system 100. Similarly, the communication system 100 may include a larger or smaller number of base stations 120 and/or APs 130 than illustrated in FIG. 1. The illustrated connections that connect the various components in the communication system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (cNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUS), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location server 160, by accessing the network 170 via a base station 120 using a first communication link 133. Additionally or alternatively, because APs 130 also may be communicatively coupled with the network 170, UE 105 may communicate with network-connected and Internet-connected devices, including location server 160, using a second communication link 135, or via one or more other mobile devices 145.

Additionally, UE 105 can send and receive information with another device such as a wearable device 136 via a third communication link 137. In the context of the present disclosure, a “wearable device” may refer to a device or accessory that is constructed to be worn (e.g., on the head), attached to, held by, or otherwise equipped by a user, and is capable of wireless communication of the types discussed herein (such as those capable by UE 105). Examples of such a wearable device may include, but are not limited to, a head-mounted display (HMD) device (e.g., XR headset), a heads-up display (HUD) device (e.g., a pair of eyeglasses with at least a portion of the lens(es) including a display screen), smart glasses having camera(s) and/or other sensor(s) such as an inertial measurement unit (IMU) having an accelerometer (to measure acceleration) and/or a gyroscope (to measure angular rate or velocity), a wrist-worn device (e.g., a smartwatch or wristband), a finger-worn device (e.g., a smart ring), and smart lenses. A wearable device may include internal power source (e.g., battery), a display (e.g., organic light-emitting diode (OLED) display), and/or one or more wireless interfaces (e.g., Bluetooth®, Wi-Fi WLAN, cellular).

In some implementations, the third communication link 137 may utilize sidelink and/or similar Device-to-Device (D2D) communication technologies as described below. In some implementations, the third communication link 137 may utilize an IEEE 802.11 standard (including Wi-Fi), Bluetooth®, or another standardized communication technology. The wearable device 136 may be configured to communicate with UE 105 via the third communication link 137 and/or base station(s) 120 via a fourth communication link 138. In some implementations, the fourth communication link 138 may include a Uu interface (e.g., in LTE or NR) as described below. Downlink and uplink communications may be performed using the third and fourth communication links 137, 138. In addition, wearable device 136 may be configured to communicate with AP(s) 130 via a fifth communication link 139, which may utilize an IEEE 802.11 standard (including Wi-Fi), Bluetooth®, or another standardized communication technology (including cellular if capable).

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (cMBB), or others) that may provide access for different types of devices. In some cases, the term “cell” may refer to a portion of a geographic coverage area (e.g., a sector) over which the logical entity operates.

Satellites 110 may be utilized for positioning of the UE 105 in one or more ways. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the UE 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120, and may be coordinated by a location server 160. In some embodiments, satellites 110 used for NTN-based positioning may be different than those used for GNSS-based positioning. In some embodiments NTN nodes may include non-terrestrial vehicles such as airplanes, balloons, drones, etc., which may be in addition or as an alternative to NTN satellites.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the communication system 100 (e.g., GNSS satellites 110, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the UE 105, or a combination thereof. Wireless signals from mobile devices 145 used for positioning of the UE 105 may comprise RF signals using, for example, Bluetooth® (including Bluetooth Low Energy (BLE)), IEEE 802.11x (e.g., Wi-Fi®), Ultra Wideband (UWB), IEEE 802.15x, or a combination thereof. Mobile devices 145 may additionally or alternatively use non-RF wireless signals for positioning of the UE 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular UE 105, the UE 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and UE 105 may comprise sidelink and/or similar Device-to-Device (D2D) communication technologies. Sidelink, which is defined by 3GPP, is a form of D2D communication under the cellular-based LTE and NR standards. UWB may be one such technology by which the positioning of a target device (e.g., UE 105) may be facilitated using measurements from one or more anchor devices (e.g., mobile devices 145).

According to some embodiments, such as when the UE 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The UE 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the UE 105 and may be used to determine the position of the UE 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the UE 105, according to some embodiments.

An estimated location of UE 105 can be used in a variety of applications—e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location (including, e.g., the location of a base station 120 or AP 130) or some other location such as a location for UE 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X. Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, or child or pet location). Additionally or alternatively, the external client 180 may obtain and provide the location of UE 105 to an emergency services provider, government agency, etc.

As previously noted, the example communication system 100 can be implemented using a wireless communication network, such as an LTE-based or 5G NR-based network. FIG. 2 shows a diagram of a 5G NR communication system 200, illustrating an embodiment of a communication system (e.g., positioning system 100) implementing 5G NR. The 5G NR communication system 200 may be configured to determine the location of a UE 105 by using access nodes, which may include NR NodeB (gNB) 210-1 and 210-2 (collectively and generically referred to herein as gNBs 210), ng-eNB 214, and/or WLAN 216 to implement one or more positioning methods. The gNBs 210 and/or the ng-eNB 214 may correspond with base stations 120 of FIG. 1, and the WLAN 216 may correspond with one or more access points 130 of FIG. 1. Optionally, the 5G NR communication system 200 additionally may be configured to determine the location of a UE 105 by using an LMF 220 (which may correspond with location server 160) to implement the one or more positioning methods. Here, the 5G NR communication system 200 comprises a UE 105, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network. In some applications, the 5G NR communication system 200 may comprise a wearable device 136 (not shown in FIG. 2) configured to communicate with the NG-RAN 235.

The 5G NR communication system 200 may further utilize information from satellites 110. As previously indicated, satellites 110 may comprise GNSS satellites from a GNSS system like Global Positioning System (GPS) or similar system (e.g. GLONASS, Galileo, Beidou, Indian Regional Navigational Satellite System (IRNSS)). Additionally or alternatively, satellites 110 may comprise NTN satellites that may be communicatively coupled with the LMF 220 and may operatively function as a TRP (or TP) in the NG-RAN 235. As such, satellites 110 may be in communication with one or more gNB 210.

It should be noted that FIG. 2 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the 5G NR communication system 200. Similarly, the 5G NR communication system 200 may include a larger (or smaller) number of satellites 110, gNBs 210, ng-eNBs 214, Wireless Local Area Networks (WLANs) 216, Access and mobility Management Functions (AMF) s 215, external clients 230, and/or other components. The illustrated connections that connect the various components in the 5G NR communication system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 105 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 105 may correspond to a cellphone, smartphone, laptop, tablet, personal data assistant (PDA), navigation device, Internet of Things (IoT) device, or some other portable or moveable device. Typically, though not necessarily, the UE 105 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 105 may also support wireless communication using a WLAN 216 which (like the one or more RATs, and as previously noted with respect to FIG. 1) may connect to other networks, such as the Internet. The use of one or more of these RATs may allow the UE 105 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 105 (e.g., via the GMLC 225). The external client 230 of FIG. 2 may correspond to external client 180 of FIG. 1, as implemented in or communicatively coupled with a 5G NR network.

The UE 105 may include a single entity or may include multiple entities, such as in a personal area network where a user may employ audio, video and/or data I/O devices, and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude), which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geodetically or in civic form) within which the UE 105 is expected to be located with some probability or confidence level (e.g., 67%, 95%, etc.). A location of the UE 105 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 105 via wireless communication between the UE 105 and one or more of the gNBs 210, which may provide wireless communications access to the 5G CN 240 on behalf of the UE 105 using 5G NR. The wireless interface between base stations (gNBs 210 and/or ng-eNB 214) and the UE 105 may be referred to as a Uu interface 239. 5G NR radio access may also be referred to as NR radio access or as 5G radio access. In FIG. 2, the serving gNB for UE 105 is assumed to be gNB 210-1, although other gNBs (e.g. gNB 210-2) may act as a serving gNB if UE 105 moves to another location or may act as a secondary gNB to provide additional throughput and bandwidth to UE 105.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (ELTE) wireless access to UE 105. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 105 but may not receive signals from UE 105 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 105. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR communication system 200, such as the LMF 220 and AMF 215.

5G NR communication system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 105 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 105 to other elements in 5G CN 240 and/or may support interworking of one or more protocols used by WLAN 216 and UE 105 to one or more protocols used by other elements of 5G CN 240 such as AMF 215. For example, N3IWF 250 may support IPSec tunnel establishment with UE 105, termination of IKEv2/IPSec protocols with UE 105, termination of N2 and N3 interfaces to 5G CN 240 for control plane and user plane, respectively, relaying of uplink (UL) and downlink (DL) control plane Non-Access Stratum (NAS) signaling between UE 105 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 105 and the AMF 215. As noted, this can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, and/or WLAN 216 (alone or in combination with other components of the 5G NR communication system 200), may be configured to, in response to receiving a request for location information from the LMF 220, obtain location measurements of uplink (UL) signals received from the UE 105) and/or obtain downlink (DL) location measurements from the UE 105 that were obtained by UE 105 for DL signals received by UE 105 from one or more access nodes. As noted, while FIG. 2 depicts access nodes (gNB 210, ng-cNB 214, and WLAN 216) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 105, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 105 may be applicable to such other networks.

The gNBs 210 and ng-eNB 214 can communicate with an AMF 215, which, for positioning functionality, communicates with an LMF 220. The AMF 215 may support mobility of the UE 105, including cell change and handover of UE 105 from an access node (e.g., gNB 210, ng-eNB 214, or WLAN 216) of a first RAT to an access node of a second RAT. The AMF 215 may also participate in supporting a signaling connection to the UE 105 and possibly data and voice bearers for the UE 105. The LMF 220 may support positioning of the UE 105 using a CP location solution when UE 105 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 105, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 105's location) may be performed at the UE 105 (e.g., by measuring downlink PRS (DL-PRS) signals transmitted by wireless nodes such as gNBs 210, ng-eNB 214 and/or WLAN 216, and/or using assistance data provided to the UE 105, e.g., by LMF 220).

The Gateway Mobile Location Center (GMLC) 225 may support a location request for the UE 105 received from an external client 230 and may forward such a location request to the AMF 215 for forwarding by the AMF 215 to the LMF 220. A location response from the LMF 220 (e.g., containing a location estimate for the UE 105) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 105 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 105 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 105 may communicate using an LTE Positioning Protocol (LPP) as defined in 3GPP TS 37.355. Here, LPP messages may be transferred between the UE 105 and the LMF 220 via the AMF 215 and a serving gNB 210-1 or serving ng-eNB 214 for UE 105. For example, LPP messages may be transferred between the LMF 220 and the AMF 215 using messages for service-based operations (e.g., based on the Hypertext Transfer Protocol (HTTP)) and may be transferred between the AMF 215 and the UE 105 using a 5G NAS protocol. The LPP protocol may be used to support positioning of UE 105 using UE assisted and/or UE based position methods such as A-GNSS, RTK, TDOA, multi-cell RTT. AoD, and/or ECID. The NRPPa protocol may be used to support positioning of UE 105 using network based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 105 access to WLAN 216, LMF 220 may use NRPPa and/or LPP to obtain a location of UE 105 in a similar manner to that just described for UE 105 access to a gNB 210 or ng-eNB 214. Thus, NRPPa messages may be transferred between a WLAN 216 and the LMF 220, via the AMF 215 and N3IWF 250 to support network-based positioning of UE 105 and/or transfer of other location information from WLAN 216 to LMF 220. Alternatively, NRPPa messages may be transferred between N3IWF 250 and the LMF 220, via the AMF 215, to support network-based positioning of UE 105 based on location related information and/or location measurements known to or accessible to N3IWF 250 and transferred from N3IWF 250 to LMF 220 using NRPPa. Similarly, LPP and/or LPP messages may be transferred between the UE 105 and the LMF 220 via the AMF 215, N3IWF 250, and serving WLAN 216 for UE 105 to support UE assisted or UE based positioning of UE 105 by LMF 220, described in more detail hereafter.

Positioning of the UE 205 in a 5G NR communication system 200 further may utilize measurements between the UE 205 and one or more other UEs 255 via a sidelink connection SL 260. As shown in FIG. 2, the one or more other UEs 255 may comprise any of a variety of different device types, including mobile phones, vehicles, roadside units (RSUs), other device types, or any combination thereof. One or more position measurement signals sent via SL 260 to the UE 205 from the one or more other UEs 255, to the one or more other UEs 255 from the UE 205, or both. Various signals may be used for position measurement, including sidelink PRS (SL-PRS). In some instances, the position of at least one of the one or more of the other UEs 255 may be determined at the same time (e.g., in the same positioning session) as the position of the UE 205. In some embodiments, the LMF 220 may coordinate the transmission of positioning signals via SL 260 between the UE 205 and the one or more other UEs 255. Additionally or alternatively, the UE 205 and the one or more other UEs 255 may coordinate a positioning session between themselves, without an LMF 220 or even a Uu connection 239 to an access node of the NG-RAN 235. To do so, the UE 205 and the one or more other UEs 255 may communicate messages via the SL 260 using sidelink positioning protocol (SLPP). In some scenarios, the one or more other UEs 255 may have a Uu connection 239 with an access node of the NG-RAN 235 and/or Wi-Fi connection with WLAN 216 when the UE 205 does not. In such instances, the one or more other UEs 255 may operate as relay devices, relaying communications to the network (e.g., LMF 220) from the UE 205. In such instances, a plurality of other UEs 255 may form a chain between the UE 205 and the access node.

In a 5G NR communication system 200, positioning methods can be categorized as being “UE assisted” or “UE based.” This may depend on where the request for determining the position of the UE 105 originated. If, for example, the request originated at the UE (e.g., from an application, or “app,” executed by the UE), the positioning method may be categorized as being UE based. If, on the other hand, the request originates from an external client 230, LMF 220, or other device or service within the 5G network, the positioning method may be categorized as being UE assisted (or “network-based”).

With a UE-assisted position method, UE 105 may obtain location measurements and send the measurements to a location server (e.g., LMF 220) for computation of a location estimate for UE 105. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), Reference Signal Time Difference (RSTD), Time of Arrival (TOA), AoA, Receive Time-Transmission Time Difference (Rx-Tx), Differential AoA (DAOA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 105 if the positions of the other UEs are known. The location measurements may also or instead include measurements for RAT-independent positioning methods such as GNSS (e.g., GNSS pseudorange, GNSS code phase, and/or GNSS carrier phase for satellites 110), WLAN, etc.

With a UE-based position method, UE 105 may obtain location measurements (e.g., which may be the same as or similar to location measurements for a UE assisted position method) and may further compute a location of UE 105 (e.g., with the help of assistance data received from a location server such as LMF 220, an SLP, or broadcast by gNBs 210, ng-eNB 214, or WLAN 216).

With a network based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ. AoA, or TOA) for signals transmitted by UE 105, and/or may receive measurements obtained by UE 105 or by an AP in WLAN 216 in the case of N3IWF 250, and may send the measurements to a location server (e.g., LMF 220) for computation of a location estimate for UE 105.

Positioning of the UE 105 also may be categorized as UL, DL, or DL-UL based, depending on the types of signals used for positioning. If, for example, positioning is based solely on signals received at the UE 105 (e.g., from a base station or other UE), the positioning may be categorized as DL based. On the other hand, if positioning is based solely on signals transmitted by the UE 105 (which may be received by a base station or other UE, for example), the positioning may be categorized as UL based. Positioning that is DL-UL based includes positioning, such as RTT-based positioning, that is based on signals that are both transmitted and received by the UE 105. Sidelink (SL)-assisted positioning comprises signals communicated between the UE 105 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

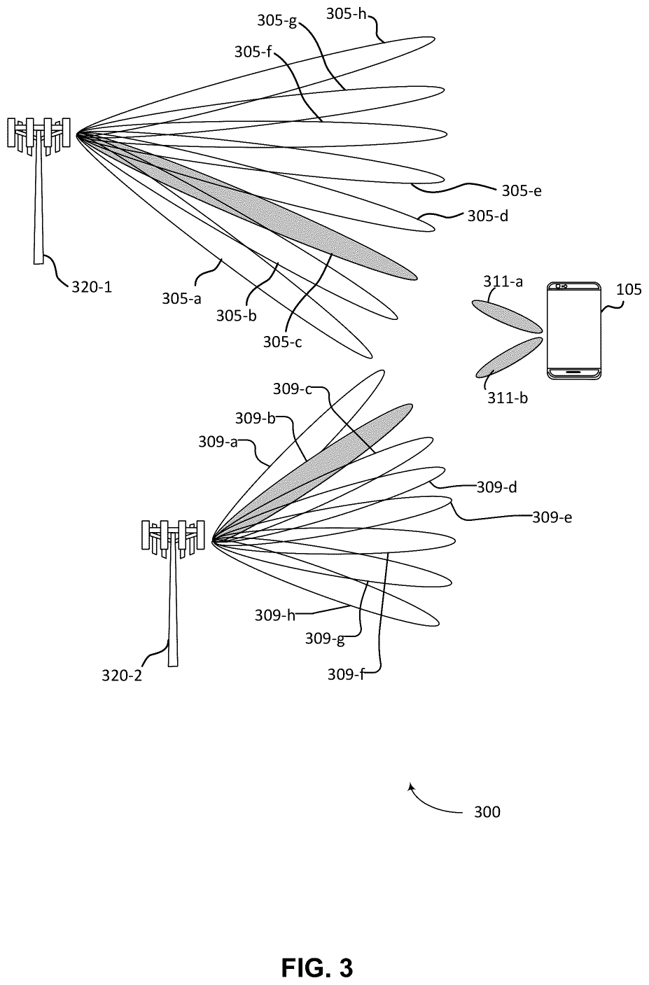

FIG. 3 is a diagram illustrating a simplified environment 300 including two base stations 320-1 and 320-2 (which may correspond to base stations 120 of FIG. 1 and/or gNBs 210 and/or ng-cNB 214 of FIG. 2) with antenna arrays that can perform beamforming to produce directional beams for transmitting and/or receiving RF signals. FIG. 3 also illustrates a UE 105, which may also use beamforming for transmitting and/or receiving RF signals. In some applications, wearable device 136 (not shown in FIG. 3) may use beamforming for transmitting and/or receiving RF signals. Such directional beams are used in 5G NR wireless communication networks. Each directional beam may have a beam width centered in a different direction, enabling different beams of a base station 320 to correspond with different areas within a coverage area for the base station 320.

Different modes of operation may enable base stations 320-1 and 320-2 to use a larger or smaller number of beams. For example, in a first mode of operation, a base station 320 may use 16 beams, in which case each beam may have a relatively wide beam width. In a second mode of operation, a base station 320 may use 64 beams, in which case each beam may have a relatively narrow beam width. Depending on the capabilities of a base station 320, the base station may use any number of beams the base station 320 may be capable of forming. The modes of operation and/or number of beams may be defined in relevant wireless standards and may correspond to different directions in either or both azimuth and elevation (e.g., horizontal and vertical directions). Different modes of operation may be used to transmit and/or receive different signal types. Additionally or alternatively, the UE 105 may be capable of using different numbers of beams, which may also correspond to different modes of operation, signal types, etc.

In some situations, a base station 320 may use beam sweeping. Beam sweeping is a process in which the base station 320 may send an RF signal in different directions using different respective beams, often in succession, effectively “sweeping” across a coverage area. For example, a base station 320 may sweep across 120 or 360 degrees in an azimuth direction, for each beam sweep, which may be periodically repeated. Each direction beam can include an RF reference signal (e.g., a PRS resource), where base station 320-1 produces a set of RF reference signals that includes Tx beams 305-a, 305-b, 305-c. 305-d, 305-e, 305-f, 305-g, and 305-h, and the base station 320-2 produces a set of RF reference signals that includes Tx beams 309-a, 309-b, 309-c, 309-d, 309-e, 309-f, 309-g, and 309-h. As noted, because UE 105 may also include an antenna array, it can receive RF reference signals transmitted by base stations 320-1 and 320-2 using beamforming to form respective receive beams (Rx beams) 311-a and 311-b. Beamforming in this manner (by base stations 320 and optionally by UEs 105) can be used to make communications more efficient. They can also be used for other purposes, including taking measurements for position determination (e.g., AoD and AoA measurements).

### Perception Sharing

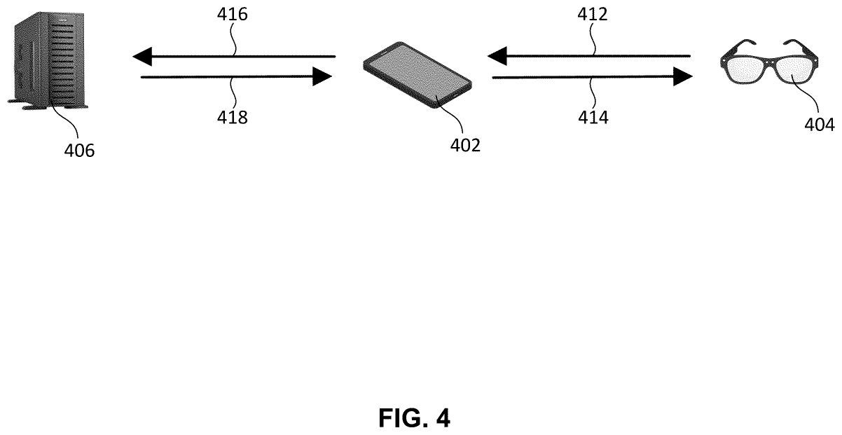

FIG. 4 is a diagram showing communications that can occur among a UE 402, a wearable device 404, and a network entity 406, according to some embodiments. The UE 402 may be an example of UE 105 (such as a smartphone) and thus may be configured to communicate with the network entity 406 in accordance with the discussions of FIG. 1, 2 or 3. The wearable device 404 may be an example of wearable device 136 and thus may be configured to communicate with the UE 402, e.g., via D2D communication. Such D2D communication between the wearable device 404 and the UE 402 may be referred to herein as phone-to-glass (P2G) communication. In some embodiments, the network entity 406 may be a server (e.g., location server 160, external client 180, LMF 220, external client 230) or an intermediary device between the server and the UE 402, such as a base station (e.g., base station 120, gNB 210, ng-eNB 214) or an access point (e.g., APs 130).

In some scenarios, the wearable device 404 may communicate with the UE 402 via P2G (or other D2D) over communication links 412, 414, and the UE 402 may in turn communicate with the network entity 406 via a cellular network (e.g., gNB) or WLAN (e.g., Wi-Fi AP) via communication links 416, 418.

In some instances, information that is communicated from the wearable device 404 to the UE 402 (e.g., via communication link 412) may include perception information such as image data (e.g., one or more optical images or RF images) captured using one or more sensors of the wearable device 404 (e.g., camera, RF sensor), RF signals, and/or information extracted from the image data or RF signals.

However, in some embodiments, a condition may need to be verified as a prerequisite to sharing the information between wearable device 404 and UE 402.

An example of such condition may include a positional relationship between the UE 402 and the wearable device 404. In some implementations, the positional relationship may include a position of the UE 402 relative to the position of the wearable device 404, a proximity between the UE 402 and the wearable device 404, a co-location of the UE 402 and the wearable device 404 at a user or a vehicle, an orientation of the UE 402 relative to an orientation of the wearable device 404, or a combination thereof. In some implementations, the position of the UE 402 relative to the position of the wearable device 404 may be determined based on an optical image obtained using the wearable device 404, or an inertial measurement of the UE 402, or both. Orientation of the UE 402 relative to orientation of the wearable device 404 can be determined based on angular measurements (as discussed below). Proximity or co-location between the UE 402 and the wearable device 404 may be determined based on a ranging measurement or inertial measurements (as discussed below).

In some implementations, the condition may be verified via user input. For example, the user may indicate that the device is in an indoor or outdoor environment, or that the UE 402 and the wearable device 404 are within view of each other, that they are within a certain proximity to each other, or that they are both being carried by the user.

Once the condition is verified, various information including perception information may be shared by the wearable device 404 to the UE 402 (or vice versa). This can ensure that the shared information will be relevant, appropriate, and usable for downstream applications at the receiving device, and thereby avoid wasting power or communication resources at both devices.

Returning to FIG. 4, another example of the shared information between the wearable device 404 to the UE 402 (e.g., via communication link 412) may include object information, such as a pose of the user's head (on which the wearable device 404 may be equipped), or a user's hand and position within the field of view of the wearable device 404.

Another example of the information may include the type of the environment, e.g., whether the wearable device 404 is indoor or outdoor. In some approaches, feature extraction, pattern recognition, feature classification, and/or similar imaging techniques may be applied to objects, lines, and other features in the image data in order to determine the type of the environment of the wearable device 404. In some approaches, detection of and connection to nearby devices such as Internet of Things (IoT) devices, APs, and/or home and office devices (e.g., smart thermostat, television, speaker, doorbell) may corroborate the type of the environment. In the foregoing, it would be implied that the device is indoor the more nearby devices are detected. Thus, the information that is communicated from the wearable device 404 to the UE 402 may include the type of the environment such as whether the wearable device 404 (and by extension, the UE 402, in some scenarios) is indoor or outdoor.

Another example of the information may relate to coverage of a wireless communication technology (e.g., radio access technology). For instance, the quality of coverage of WLAN (e.g., Wi-Fi) or cellular (e.g., 5G) signals may be determined and communicated from the wearable device 404 to the UE 402. In some implementations, the quality may be measured in signal strength, e.g., RSSI or signal-to-noise ratio (SNR). In some implementations, the quality may be learned, estimated, or determined from past measurements.

In some instances, information that is communicated from the wearable device 404 to the UE 402 may include a position of the wearable device 404, e.g., an absolute position in a given coordinate system, a relative position of the wearable device 404 to the UE 402 and/or a distance between the wearable device 404 to the UE 402. In some instances, information that is communicated from the wearable device 404 to the UE 402 may include an orientation of the wearable device 404. Collectively, the position and the orientation may be referred to as a “pose” herein.

In some embodiments, the wearable device 404 may determine its position and/or pose based at least on visual detection involving spatial anchors (common frames of reference), additional sensor data (e.g., from an IMU of the wearable device 404), wireless RF measurements (e.g., angular measurements, ranging measurements), or a combination thereof, in a six degrees of freedom (6DOF) system. These mechanisms for obtaining position and/or pose will be detailed below.

One example approach for the visual detection may include the UE 402 being introduced within the field of view of the wearable device 404 (e.g., the field of view of a camera of the wearable device 404). A user may move the UE 402 or the wearable device 404 such that the UE 402 is within the field of view, for instance. The wearable device 404 may then identify the UE 402 and the relative position thereto. Recognition of the UE 402 by the wearable device 404 may be based on, e.g., feature extraction, pattern recognition, and/or feature classification as mentioned above. In some implementations, motion sensor data from the UE 402 (e.g., acceleration, angular rate or velocity, and/or rotation measurements from an IMU of the UE 402) can be further used to confirm the identity of the visually detected UE 402, e.g., by comparing the motion of the visually detected UE 402 with the motion sensor data from the UE 402. Comparable accelerations or rotations may indicate or confirm that the visually identified UE 402 is the device to determine the distance with. In some implementations, the relative position of the wearable device 404 relative to the UE 402 can be estimated based on a spatial anchor, e.g., known distance to other objects in the environment or known size of the object (e.g., a UE rendered in an image with x number of pixels may correspond to a distance of y). The UE 402 and the wearable device 404 may share a common set of identified objects or visual features.

Another example approach for the visual detection may include gaining a stereo understanding of the environment. In some implementations, one or more depth maps may be generated to indicate or represent the distances of features and objects in one or more scenes (e.g., based on respective fields of view of a camera of the wearable device 404). An example of a depth map may be an image of the scene having darker colors over surfaces that are nearer to the camera or the focal plane and lighter colors over surfaces that are farther from the camera or the focal plane. In some cases, based at least on combining the one or more depth maps, a three-dimensional representation of the environment may be reconstructed. For instance, a room with walls and objects (including, e.g., UE 402) may be reconstructed, which may be rendered as a stereo images projectable on the wearable device 404.

Another example approach for the visual detection may include using the motion sensor data from the UE 402 with the visual tracking of the UE 402 by the wearable device 404 to keep the relative position of the wearable device 404 known over time. In one scenario, the UE 402 may be detected as placed on a table. As long as the motion sensor data of the UE 402 indicates no motion, or even without confirming with the UE's motion sensor data, the position of the UE 402 may be assumed to be known based on the fixed position of the UE 402. In some scenarios, the UE 402 may be in the visual field of view of the wearable device 404 at least some of the time, and the motion sensor data of the UE 402 may be used to track the UE 402 for short periods of time when it is not in the field of view. For example, acceleration could be measured to estimate a distance traversed by the UE 402. An estimated direction of the motion of the UE 402 may also be measured temporarily based on orientation of the UE 402 based on angular velocity with respect to a reference (e.g., initial) orientation. Such additional motion sensor data may increase the precision or fineness of the relative position or orientation of the devices. However, accuracy of IMU-only position tracking may be reliable over a limited period of time because of dead reckoning drift.

In some implementations, RF sensing may be performed by the UE 402 or the wearable device 404 via the existing communication link 412 or 414 to estimate pose. For example, one or more Wi-Fi or Bluetooth signals may be used to measure angular measurements, e.g., an angle of arrival (AoA) or angle of departure (AoD), which may provide relative direction and thereby the relative pose. AoA and AoD may be measured depending on the number of antennas on the measuring device (e.g., to determine per-antenna angles or phase). As another example, relative distance between the UE 402 and the wearable device 404 may be determined via RTT or time of flight (TOF) measurements.

Commonly, a user equipping the wearable device 404 is likely to carry or have the UE 402 nearby. Hence, in some situations, the UE 402 and the wearable device 404 may be in relative proximity to each other, which may be another way to verify a condition to perform perception sharing.

In some implementations, RF sensing may be performed by the UE 402 or the wearable device 404 via the existing communication link 412 or 414 to estimate proximity. In some cases, ranging measurements may be obtained using Wi-Fi or Bluetooth, e.g., via RTT, TOF, signal strength measurement such as RSSI or SNR. While RTT and TOF may more directly measure the distance and thereby relative proximity, proximity may be implied and estimated based on signal strength, where, for example, the stronger the signal strength, the closer the UE 402 is to the wearable device 404.

In some implementations, RF sensing may be performed by the UE 402 or the wearable device 404 using backscattering to estimate proximity. The UE 402 or the wearable device 404 may, at times, not be coupled via a wireless link with the other device but may have a reflector with a unique signature or identifier. An RF signal may be sent by one device (to the other device and have a reflection coming back from the other device with a certain expected signature. In some situations, the UE 402 or the wearable device 404 may determine proximity or co-location using an RF device such as a radio-frequency identification (RFID) tag.

Returning to FIG. 4, in some embodiments, the UE 402 may send information to the wearable device 404 via communication link 414. Such information may include image data, such as rendered images obtained using the UE 402. The wearable device 404 may then be able to display the images to the user, e.g., via the display device on the wearable device 404. In some embodiments, the UE 402 may send information to the wearable device 404 of the kind sent via the communication link 412 (from wearable device 404 to UE 402).

In some embodiments, the UE 402 may also send information to the network device 406 via communication link 416. Information sent to the network device 406 may include any type of information occurring during normal usage of the UE 402. In some cases, information regarding hand tracking and head pose obtained previously may be sent to the network device 406.

In some embodiments, the UE 402 may receive information from the network device 406 via communication link 418. Information from the network device 406 may include any type of information occurring during normal usage of the UE 402. In some cases, the information regarding a location of the UE 402 (e.g., in a UE-assisted position method) or APs or base stations in the area, which may provide further indications about the type of the environment.

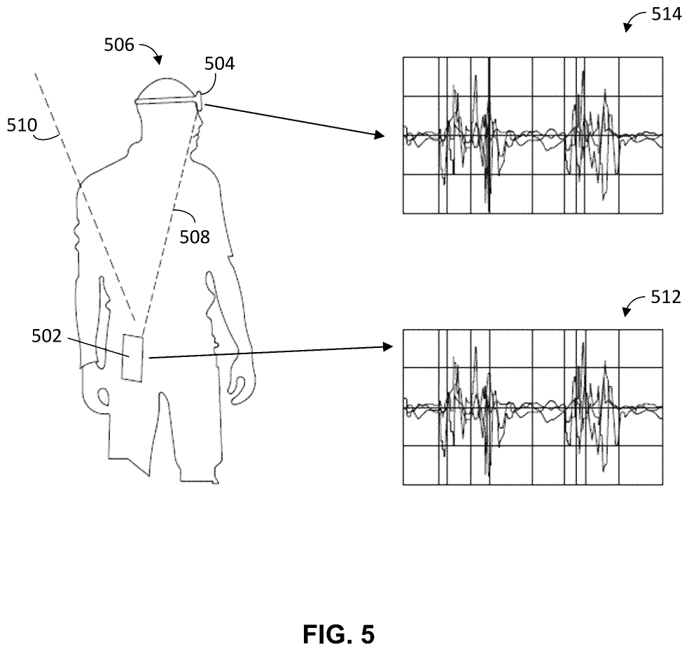

FIG. 5 showing an example of using inertial measurements at the UE 502 and the wearable device 504 to verify a condition for perception sharing, according to some embodiments. As shown, a user 506 may have the UE 502 in a pocket, holster, hand, or otherwise attached or secured to the person of the user 506, and the wearable device 504 worn on the head. FIG. 5 is an illustrative example of a user 506 equipping or carrying the UE 502 and the wearable device 504. The user 506 may have the devices carried or equipped in other ways. In other scenarios, the UE 502 and the wearable device 504 may be placed within the same vehicle (e.g., car, animal) or container (e.g., box, bag). In some scenarios, multiple users, vehicles, containers, etc. (e.g., a train) may be joined or chained together with the UE 502 and the wearable device 504 on different users or vehicles. In some implementations, multiple UEs and/or multiple wearable devices may be equipped by the user, vehicle, container, etc.

In some embodiments, the UE 502 may measure, generate, or obtain measurement(s) 512 indicative of motion of the UE 502. The measurements 512 may include an acceleration measurement, a rotation measurement (e.g., angular rate or velocity), or a combination thereof, and may be measured using at least one inertial sensor of the UE 502 (e.g., using an output of an IMU of the UE 502).

In some embodiments, the wearable device 504 may measure, generate, or obtain measurement(s) 514 indicative of motion of the wearable device 504. The measurements 514 may include an acceleration measurement, a rotation measurement (e.g., angular rate or velocity), or a combination thereof, and may be measured using at least one inertial sensor of the wearable device 504 (e.g., using an output of an IMU of the wearable device 504).

Then, the measurements 512 and 514 may be evaluated against each other. For example, sensor outputs of the UE 502 may be compared with sensor outputs of the wearable device 504. If the UE 502 and the wearable device 504 are carried by the same user (or vehicle, container, etc.), a high correlation between the measurements 512 and 514 is expected. This is because a user taking steps or moving the body, or a vehicle experiencing the same road condition or irregularities, or the overall direction or movement of the user or vehicle will result in similar acceleration and rotation. Otherwise, it is expected that there will be low correlation.

In some implementations, measurements 512 and 514 may be sent or received between the UE 502 and the wearable device 504 via a communication link 508. Measurements 512 and 514 may be exchanged at least once and/or at periodic intervals to perform the evaluation at the UE 502 or the wearable device 504. In some implementations, the degree of correlation between measurements 512 and 514 may be determined based on the measurements 512 and 514 being within a threshold difference or a range of values of each other. In some cases, multiple high correlations (e.g., a threshold number selected based on desired precision) over time may be needed to confirm and determine a high correlation between the measurements 512 and 514.

Accordingly, the UE 502 (or wearable device 504) may detect that the UE 502 and the wearable device 504 are carried by the same person or user (or vehicle, container, etc. This detection may further indicate proximity or co-location of the UE 502 and the wearable device 504 as well. In some embodiments, this determination may be a condition to be verified before the wearable device 504 shares perception information to the UE 502 (or vice versa), as discussed above.

In various approaches, conditions to be verified may vary depending on the information to be shared. In one example, to share the type of an environment (e.g., indoor or outdoor) obtained, e.g., using a camera of the wearable device, the condition to be verified may include the UE and the wearable device being carried by the same user or vehicle, or a relative proximity of the UE and the wearable device. In another example, to share a position of the wearable device within an environment and/or a relative position of the wearable device to the UE, the condition to be verified may include the UE and the wearable device being carried by the same user or vehicle, or a relative position of the wearable device to the UE as discussed above. In another example, to share a position and/or pose of the wearable device, the condition to be verified may include position, orientation, or pose of the wearable device relative to the UE as discussed above.

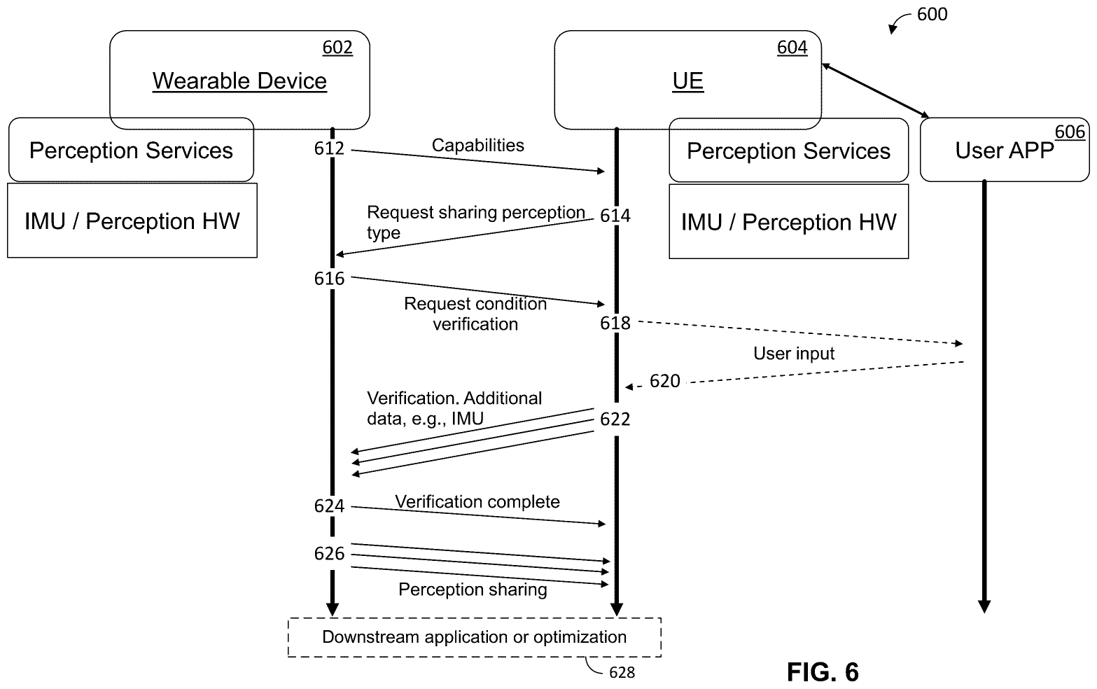

FIG. 6 is an example diagram of a call flow 600 showing signals exchanged between a wearable device 602 and a UE 604 to allow perception sharing, according to some embodiments. In some embodiments, the wearable device 602 may include one or more hardware and software components, such as an IMU and/or other sensors (e.g., cameras, RF sensors), and applications and services executable by an operating system configured to be run on the wearable device 602 (e.g., in user and kernel spaces). Similarly, the UE 604 may include one or more hardware and software components, such as an IMU and/or other sensors (e.g., cameras, RF sensors), and applications and services executable by an operating system configured to be run on the UE 604 (e.g., in user and kernel spaces). In some embodiments, the UE 604 may include or be in data communication with a user application 606. In some implementations, the user application 606 may be one of the applications executable on the UE 604, which will be further discussed below.

In some embodiments, the call flow 600 may include one or more of the following operations. At arrow 612, the wearable device 602 may send capabilities information to the UE 604. In some implementations, the capabilities information may include a list of sharable perception information. Examples of sharable perception information may include the type of environment (e.g., indoor/outdoor), image data (e.g., depth map(s), optical image(s)), position (e.g., absolute in in a given coordinate system in the environment, or relative to another device), orientation, and/or pose, associated with the wearable device 602, as described elsewhere herein.

At arrow 614, the UE 604 may send to the wearable device 602 a request to share (e.g., send to the UE 604) at least one kind of information, based on the capabilities information from arrow 612. The kind of information may depend on the desired downstream application and may have a level of coarseness or fineness required for such application associated with the information (e.g., position and pose would have a higher level of precision than type of environment).

At arrow 616, the wearable device 602 may send a request to start verification of a condition (or conditions) to share the requested information from arrow 614.

In some implementations, initiating the condition verification may require user input or user intervention. To this end, optionally, the UE 604 may request the user input at arrow 618, and wait for the user input from the user application 606. The user application 606 may be accessible via the UE 604 itself (e.g., via a touchscreen of a smartphone). In some variants, the user application 606 may be at another device configured for data communication with the UE 604, such as a separate input device or another UE.

In response, at arrow 620, the user may provide input (e.g., to proceed with condition verification) through the user application 606 to the UE 604. In some cases, the condition verification may be provided by the user itself, e.g., via at arrow 620. For example, the user may indicate that the wearable device 602 and the UE 604 are co-located or carried by the same user, or that the devices are indoor or outdoor.

At arrow 622, the UE 604 may perform verification of the condition(s). In some implementations, the condition(s) may include a positional relationship between the wearable device 602 and the UE 604, e.g., detecting that the wearable device and the UE are carried by the same user or a vehicle, or relative position and/or pose of the wearable device and the UE of varying precision. Such positional relationship may be a position of the UE 604 relative to the position of the wearable device 602, a proximity between these devices, a co-location of these devices, an orientation of the UE 604 relative to an orientation of the wearable device 602, or a combination thereof. The foregoing positional relationships may be determined according to the approaches described above, and may in some implementations involve measurements obtained from the hardware (e.g., IMU and/or other sensors) on the wearable device 602 and/or hardware on the UE 604. An indication of the verification of the condition, e.g., which conditions have been verified, may be sent to the wearable device 602.

At arrow 624, the wearable device 602 may determine that the verification of the condition(s) is complete. This determination may include matching the condition(s) to be verified with the type of perception information to be shared, and the determination may also be indicated to the UE 604.

At this point, the UE 604 and the wearable device 602 may be aware that both devices are within certain proximity and/or pose relative to each other. Whatever the wearable device 602 is experiencing (e.g., being in an outdoor setting), it is deemed likely that the UE 604 is also is experiencing it (e.g., also in an outdoor setting). For instance, a user wearing the wearable device 602 may be carrying the UE 604 in a pocket outside, or the UE 604 on an indoor table may be a certain distance and direction away from the wearable device 602.

At arrow 626, the wearable device 602 may send the aforementioned perception information to the UE 604 (e.g., the type of environment (e.g., indoor/outdoor), image data (e.g., depth map(s), optical image(s)), position, orientation, and/or pose, associated with the wearable device 602). A P2G communication link such as communication link 412 may be used to receive information at the UE 604, as well as perform arrows 612, 616 and 624. Conversely, a P2G communication link such as communication link 414 may be used to send information to the wearable device 602. e.g., to perform arrows 614 and 622.

At block 628, the UE 604 may perform a downstream application or optimize a configuration of the UE 604. In some embodiments, the UE 604 may switch to a more appropriate radio access network while moving from venue to venue. For instance, the UE 604 may proactively connect to a cellular base station rather than staying on a Wi-Fi AP, based on the received information at arrow 626 indicating that the wearable device 602 (and by extension, the UE 604) is outdoor. Typically, transitioning from a Wi-Fi AP to a cellular base station involves a period of low connectivity because the Wi-Fi connection attempts to stay connected despite the weaker signal. However, the switching based on the outdoor perception received from the wearable device 602 can advantageously reduce the “stickiness” of the Wi-Fi connection at the home AP when moving from an indoor setting (e.g., home) to outside, resulting in less interruption of data connectivity.

In some embodiments, the UE 604 may optimize connections or association to access points. For example, based on a precise position of the UE 604, it may select the closest AP out of the known APs in the room or venue. As another example, despite not knowing where it is, the UE 604 may perform navigation applications (e.g., displaying a position on a map, instructions to reach a certain room, or advertisements in a mall) using image or positional data received from the wearable device 602. As another example, the UE 604 may send to the network (e.g., using communication link 416) information about the position of the UE 604. A network provider may use the position of the UE 604 to determine and/or map network conditions (e.g., heatmap indicating connectivity in an area), or make evaluations about whether or not the network or network nodes are working properly.

In some embodiments, the UE 604 may optimize beamforming. Consider a scenario in which the wearable device 602 or another object is positioned between the UE 604 and a first base station such as base station 320-1, obstructing signal paths between the UE 604 and the first base station 320-1. If the relative position or pose (in conjunction with depth information from a depth map) of the wearable device 602 is known to the UE 604 from the received perception information of the wearable device 602, and if the position of the first base station 320-1 is known to the UE 604 (e.g., information received from the network via communication link 418), then the UE 604 may know that beamforming with the first base station 320-1 for transmitting and/or receiving RF signals is likely to be less effective since the receive beam 311-a for the first base station 320-1 is obstructed. In contrast, the UE 604 may know that beamforming with a second base station 320-2 may be more effective than with the first base station 320-1, since the UE 604 is aware, at least based on the received perception information of the wearable device 602, that there is no obstruction of the receive beam 311-b for the second base station 320-2.

Accordingly, in some embodiments, based on the received perception information, UE 604 may select one receive beam over another, e.g., receive beam 311-b rather than receive beam 311-a, even in scenarios where the first base station 320-1 happens to be closer to the UE 604 than the second base station 320-2. Hence, position and pose information received from the wearable device 602 can advantageously improve cellular link (e.g., 5G link) and connectivity.

Consider another scenario where the pose information of the wearable device 602 indicates that the user is facing or oriented toward the first base station 320-1 while holding the UE 604 in front, which may be visually detected in the image data of the wearable device 602. That is, the wearable device 602 or other objects are not obstructing signal paths to the first base station 320-1. The UE 604 may infer, from the position and pose information of the wearable device 602 (and/or image data including depth map indicating no other obstruction), that beamforming with the first base station 320-1 is likely more efficient than beamforming with another base station. Here, again, UE 604 may select a receive beam based on the received perception information. However, the outcome here is different compared to the previous scenario for the same first base station 320-1, although the cellular link is optimized in either scenario.

In other embodiments, the wearable device 602 and the UE 604 may perform reversed roles and be configured to perform the operations of the other. For example, the UE 604 may initiate the operations shown in the call flow 600 by sending capabilities information (e.g., arrow 612) to the wearable device 602, share perception information (e.g., arrow 626, e.g., that the UE 604 is in a car, an airplane, or another vehicle, or is walking outdoor, etc.), and so on. For brevity, counterpart discussion of the rest of the arrows is omitted.

In general, the wearable device 602 and the UE 604 can be considered part of a “personal network” of devices, which may include an HMD (e.g., the wearable device 602), a mobile device (e.g., the UE 604), a smartwatch, a smart ring, earbuds, etc. As long as these devices are aware that they are co-located, they can share their perception information among one another. That is to say, more than three or devices (not just the two example devices wearable device and UE discussed herein) can share perception information among themselves and/or other co-located devices.

Further, it is to be understood that the result may be that wearable device 602 can perform its own downstream applications, similar to the UE 604 as described above with respect to block 628. One example of a downstream application for the wearable device 602 may include using the UE 604 as a controller or tracker (e.g., for a user's hand(s)) within an XR application experienced through the wearable device 602. By tracking the relative positions of the wearable device 602 and the UE 604 (e.g., the UE 604 can send its orientation, rotation, or distance information to the wearable device 602), actions of the user by moving the UE 604 can be sent to the wearable device 602. In XR applications, using the UE 604 as a controller or tracking the user's hand can cause interactions with virtual objects or real objects in the scene viewed through the wearable device 602.

### Methods

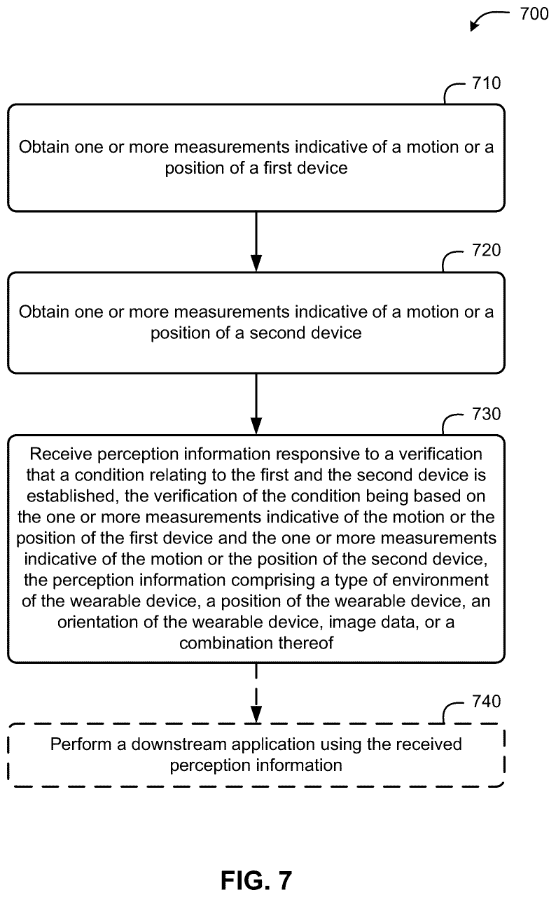

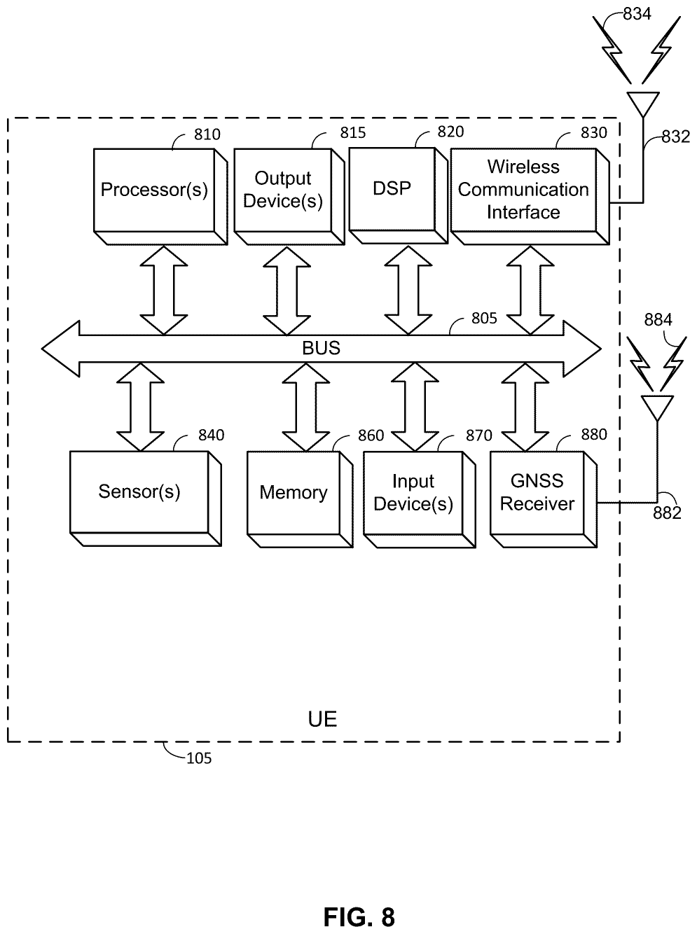

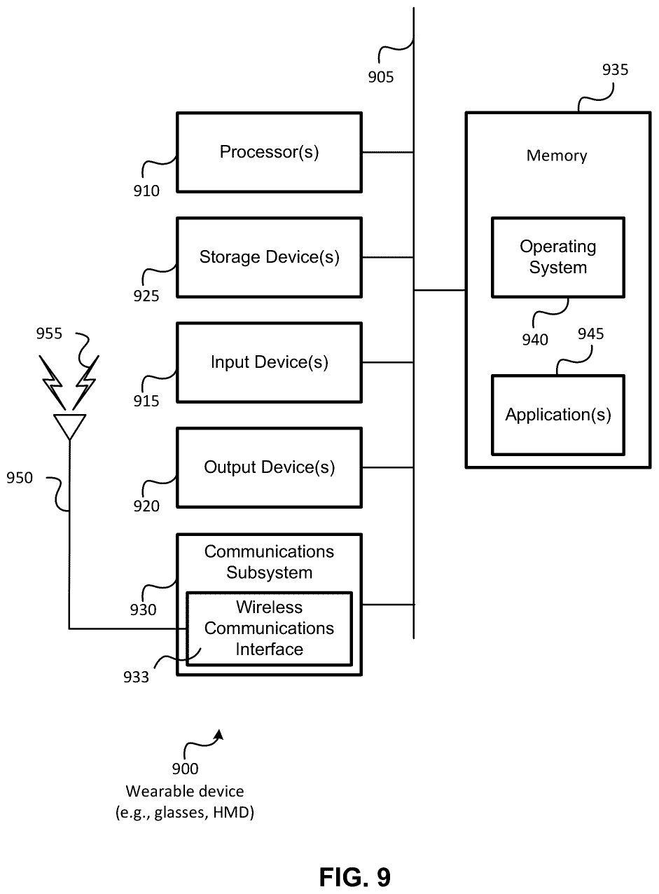

FIG. 7 is a flow diagram of a method 700 of sharing perception information between a first device and a second device, according to an embodiment. Structure for performing the functionality illustrated in one or more of the blocks shown in FIG. 7 may be performed by hardware and/or software components of a wireless-enabled device such as a UE or a wearable device. Components of such wireless-enabled device may include, for example, one or more transceivers, one or more wireless communication interfaces, one or more sensors, one or more processors, one or more memory, and/or one or more computer-readable apparatus including a storage medium storing computer-readable and/or computer-executable instructions that are configured to, when executed by one or more processors, cause the one or more processors or the wireless-enabled device to perform operations represented by blocks below. Example components of a UE and a wireless device are illustrated in FIGS. 8 and 9, respectively, which are described in more detail below.

It should also be noted that the operations of FIG. 7 may be performed in any suitable order, not necessarily the order depicted in FIG. 7. Further, the process shown in FIG. 7 may include additional or fewer operations than those depicted in FIG. 7.

At block 710, the method 700 may include obtaining one or more measurements indicative of a motion or a position of the first device. In some embodiments, the first device may comprise a UE (e.g., smartphone, laptop). In some embodiments, obtaining the one or more measurements indicative of the motion or the position of the UE may include obtaining one or more first measurements comprising an acceleration measurement, a rotation measurement, or a combination thereof, the one or more first measurements measured using at least one inertial sensor of the first device.

Means for performing functionality at block 710 may comprise a bus 805 or 905, wireless communication interface 830 or 933, wireless antenna(s) 832 or 950, memory 860, storage device(s) 925, and/or other components of a UE or server, as illustrated in FIGS. 8 and 9.

At block 720, the method 700 may include obtaining one or more measurements indicative of a motion or a position of the second device. In some embodiments, the second device may comprise a wearable device. In some implementations, the wearable device may include a head-mounted display (HMD) or a heads-up display (HUD). The HMD or HUD may be part of various devices discussed elsewhere herein, such as an XR headset, eyeglasses, or smart glasses or having sensors (e.g., camera(s) and/or other sensors(s) such as an IMU). In some embodiments, obtaining the one or more measurements indicative of the motion or the position of the wearable device comprises obtaining one or more second measurements comprising an acceleration measurement, a rotation measurement, or a combination thereof, the one or more second measurements measured using at least one inertial sensor of the wearable device.

In some embodiments, obtaining the one or more measurements indicative of the motion or the position of the second device (e.g., a wearable device) may include receiving (e.g., at the first device such as a UE) the one or more measurements indicative of the motion of the second device from the second device; and receiving (e.g., at the first device such as a UE) the perception information may include receiving the perception information from the second device. In some implementations, the method 700 may further include sending a request for the perception information to the second device, and receiving the perception information may be responsive to the request.

At block 730, the method 700 may include receiving perception information responsive to a verification that a condition relating to the first device and the second device is established. In some embodiments, the verification of the condition may be based on the one or more measurements indicative of the motion or the position of the first device (obtained at block 710) and the one or more measurements indicative of the motion or the position of the second device (obtained at block 720). In some implementations, the verification of the condition may be based on a correlation of one or more first measurements and the one or more second measurements. In some embodiments, the perception information may include a type of environment of the second device, a position of the second device, an orientation of the second device, image data (e.g., depth map(s), optical image(s)), or a combination thereof.

In some embodiments, the condition may include a positional relationship between the first device (e.g., UE) and the second device (e.g., wearable device). In some embodiments, the positional relationship may include a position of the first device relative to the position of the second device, a proximity between the first device and the second device, a co-location of the first device and the second device, an orientation of the first device relative to the orientation of the second device, or a combination thereof. In some implementations, the method 700 may further include determining the position of the first device relative to the position of the second device based on an optical image obtained using the second device, an inertial measurement of the first device, or a combination thereof. In some other implementations, the method 700 may further include determining the orientation of the first device relative to the orientation of the second device based on an angle of arrival or an angle of departure of a radio frequency (RF) signal between the first device and the second device. In some other implementations, determining the proximity between the first device and the second device based on at least one ranging measurement between the first device and the second device. In some other implementations, the method 700 may further include determining the co-location of the first device and the second device based on a correlation of one or more inertial measurements of the first device and one or more inertial measurements of the second device.

In some embodiments, the type of the environment may include an indoor environment or an outdoor environment, the type of the environment detected using one or more sensors of the second device (e.g., the wearable device).

In some embodiments, the method 700 may further include receiving information about one or more types of perception information that is capable of being shared; sending a request for at least one of the received one or more types of perception information; and initiating the verification of the condition responsive to a request to initiate the verification of the condition. In some implementations, the method 700 may further include receiving a user input configured to confirm the initiation of the verification of the condition.

In some scenarios, at block 740, the method 700 may further include performing an application, such as an optimized downstream application, using the received perception information. In some embodiments, the downstream application may include switching from a first wireless communication protocol to a second wireless communication protocol, selecting an access point from a plurality of access points, selecting a beam from a plurality for beams associated with one or more base stations, or performing a position-based operation using the received perception information.

### Apparatus

FIG. 8 is a block diagram of an embodiment of a UE 105, which can be utilized as described herein above (e.g., in association with FIGS. 1-7). For example, the UE 105 can perform one or more of the functions of the method shown in FIG. 7. It should be noted that FIG. 8 is meant only to provide a generalized illustration of various components, any or all of which may be utilized as appropriate. It can be noted that, in some instances, components illustrated by FIG. 8 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 8.

The UE 105 is shown comprising hardware elements that can be electrically coupled via a bus 805 (or may otherwise be in communication, as appropriate). The hardware elements may include a processor(s) 810 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 810 may comprise one or more processing units, which may be housed in a single integrated circuit (IC) or multiple ICs. As shown in FIG. 8, some embodiments may have a separate DSP 820, depending on desired functionality. Location determination and/or other determinations based on wireless communication may be provided in the processor(s) 810 and/or wireless communication interface 830 (discussed below). The UE 105 also can include one or more input devices 870, which can include without limitation one or more keyboards, touch screens, touch pads, microphones, buttons, dials, switches, and/or the like; and one or more output devices 815, which can include without limitation one or more displays (e.g., touch screens), light emitting diodes (LEDs), speakers, and/or the like.

The UE 105 may also include a wireless communication interface 830, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 105 to communicate with other devices as described in the embodiments above. The wireless communication interface 830 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 832 that send and/or receive wireless signals 834. According to some embodiments, the wireless communication antenna(s) 832 may comprise a plurality of discrete antennas, antenna arrays, or any combination thereof. The antenna(s) 832 may be capable of transmitting and receiving wireless signals using beams (e.g., Tx beams and Rx beams). Beam formation may be performed using digital and/or analog beam formation techniques, with respective digital and/or analog circuitry. The wireless communication interface 830 may include such circuitry.

Depending on desired functionality, the wireless communication interface 830 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 105 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 105 can further include sensor(s) 840. Sensor(s) 840 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 105 may also include a Global Navigation Satellite System (GNSS) receiver 880 capable of receiving signals 884 from one or more GNSS satellites using an antenna 882 (which could be the same as antenna 832). Positioning based on GNSS signal measurement can be utilized to complement and/or incorporate the techniques described herein. The GNSS receiver 880 can extract a position of the UE 105, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 880 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 880 is illustrated in FIG. 8 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 810, DSP 820, and/or a processor within the wireless communication interface 830 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 810 or DSP 820.

The UE 105 may further include and/or be in communication with a memory 860. The memory 860 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 860 of the UE 105 also can comprise software elements (not shown in FIG. 8), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 860 that are executable by the UE 105 (and/or processor(s) 810 or DSP 820 within UE 105). In some embodiments, then, such code and/or instructions can be used to configure and/or adapt a general-purpose computer (or other device) to perform one or more operations in accordance with the described methods.

FIG. 9 is a block diagram of an embodiment of a computerized system 900, which may be used, in whole or in part, to provide the functions of a wearable device as described in the embodiments herein (e.g., wearable device 136, 404, 504, 602). It should be noted that FIG. 9 is meant only to provide a generalized illustration of various components, any or all of which may be utilized as appropriate. FIG. 9, therefore, broadly illustrates how individual system elements may be implemented in a relatively separated or relatively more integrated manner. In addition, it can be noted that components illustrated by FIG. 9 can be localized to a single device and/or distributed among various networked devices, which may be disposed at different geographical locations.

The computerized system 900 is shown comprising hardware elements that can be electrically coupled via a bus 905 (or may otherwise be in communication, as appropriate). The hardware elements may include processor(s) 910, which may comprise without limitation one or more general-purpose processors, one or more special-purpose processors (such as digital signal processing chips, graphics acceleration processors, and/or the like), and/or other processing structure, which can be configured to perform one or more of the methods described herein. The computerized system 900 also may comprise one or more input devices 915, which may comprise without limitation a mouse, a keyboard, a camera, a microphone, and/or the like; and one or more output devices 920, which may comprise without limitation a display device, a printer, and/or the like.

The computerized system 900 may further include (and/or be in communication with) one or more non-transitory storage devices 925, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computerized system 900 may also include a communications subsystem 930, which may comprise wireless communication technologies managed and controlled by a wireless communication interface 933, as well as wired technologies (such as Ethernet, coaxial communications, universal serial bus (USB), and the like). The wireless communication interface 933 may comprise one or more wireless transceivers that may send and receive wireless signals 955 (e.g., signals according to 5G NR or LTE) via wireless antenna(s) 950. Thus the communications subsystem 930 may comprise a modem, a network card (wireless or wired), an infrared communication device, a wireless communication device, and/or a chipset, and/or the like, which may enable the computerized system 900 to communicate on any or all of the communication networks described herein to any device on the respective network, including a User Equipment (UE), base stations and/or other TRPs, and/or any other electronic devices described herein. Hence, the communications subsystem 930 may be used to receive and send data as described in the embodiments herein.

In many embodiments, the computerized system 900 will further comprise a working memory 935, which may comprise a RAM or ROM device, as described above. Software elements, shown as being located within the working memory 935, may comprise an operating system 940, device drivers, executable libraries, and/or other code, such as one or more applications 945, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 925 described above. In some cases, the storage medium might be incorporated within a computer system, such as computerized system 900. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computerized system 900 and/or might take the form of source and/or installable code, which, upon compilation and/or installation on the computerized system 900 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1. A method of sharing perception information between a first device and a second device, the method comprising: obtaining one or more measurements indicative of a motion or a position of the first device; obtaining one or more measurements indicative of a motion or a position of the second device; and receiving perception information responsive to a verification that a condition relating to the first device and the second device is established, the verification of the condition being based on the one or more measurements indicative of the motion or the position of the first device and the one or more measurements indicative of the motion or the position of the second device, the perception information comprising a type of environment of the second device, a position of the second device, an orientation of the second device, image data, or a combination thereof.
Clause 2. The method of clause 1, wherein the first device comprises a user equipment (UE), the second device comprises a wearable device, and the condition comprises a positional relationship between the UE and the wearable device.
Clause 3. The method of any one of clauses 1-2 wherein the wearable device comprises a head-mounted display, a heads-up display, a wrist-worn device, or a finger-worn device.
Clause 4. The method of any one of clauses 1-3 the positional relationship comprises a position of the first device relative to the position of the second device, a proximity between the first device and the second device, a co-location of the first device and the second device, an orientation of the first device relative to the orientation of the second device, or a combination thereof.
Clause 5. The method of any one of clauses 1-4 further comprising determining the position of the first device relative to the position of the second device based on an optical image obtained using the second device, an inertial measurement of the first device, or a combination thereof.
Clause 6. The method of any one of clauses 1-5 further comprising determining the orientation of the first device relative to the orientation of the second device based on an angle of arrival or an angle of departure of a radio frequency (RF) signal between the first device and the second device.
Clause 7. The method of any one of clauses 1-6 further comprising determining the proximity between the first device and the second device based on at least one ranging measurement between the first device and the second device.
Clause 8. The method of any one of clauses 1-7 further comprising determining the co-location of the first device and the second device based on a correlation of one or more inertial measurements of the first device and one or more inertial measurements of the second device.
Clause 9. The method of any one of clauses 1-8 wherein obtaining the one or more measurements indicative of the motion of the first device comprises obtaining one or more first measurements comprising an acceleration measurement, a rotation measurement, or a combination thereof, the one or more first measurements measured using at least one inertial sensor of the first device; obtaining the one or more measurements indicative of the motion of the second device comprises obtaining one or more second measurements comprising an acceleration measurement, a rotation measurement, or a combination thereof, the one or more second measurements measured using at least one inertial sensor of the second device; and the verification of the condition is based on a correlation of one or more first measurements and the one or more second measurements.
Clause 10. The method of any one of clauses 1-9 wherein obtaining the one or more measurements indicative of the motion of the second device comprises receiving the one or more measurements indicative of the motion of the second device from the second device; and receiving the perception information comprises receiving the perception information from the second device.
Clause 11. The method of any one of clauses 1-10 further comprising sending a request for the perception information to the second device; wherein the receiving the perception information is responsive to the request.
Clause 12. The method of any one of clauses 1-11 further comprising performing an application using the received perception information, the application comprising switching from a first wireless communication protocol to a second wireless communication protocol, selecting an access point from a plurality of access points, selecting a beam from a plurality for beams associated with one or more base stations, or performing a position-based operation using the received perception information.
Clause 13. The method of any one of clauses 1-12 wherein the type of the environment comprises an indoor environment or an outdoor environment, the type of the environment detected using one or more sensors of the second device.
Clause 14. The method of any one of clauses 1-13 further comprising receiving information about one or more types of perception information that is capable of being shared; sending a request for at least one of the one or more types of perception information; and initiating the verification of the condition responsive to a request to initiate the verification of the condition.
Clause 15. The method of any one of clauses 1-14 further comprising receiving a user input configured to confirm the initiating of the verification of the condition.
Clause 16. An apparatus comprising: one or more wireless communication interfaces; one or more sensors; one or more memory; and one or more processors coupled to the one or more wireless communication interfaces, the one or more sensors, and the one or more memory, and configured to: obtain one or more measurements indicative of a motion or a position of a first device; obtain one or more measurements indicative of a motion or a position of a second device; and receive perception information responsive to a verification that a condition relating to the first device and the second device is established, the verification of the condition being based on the one or more measurements indicative of the motion or the position of the first device and the one or more measurements indicative of the motion or the position of the second device, the perception information comprising a type of environment of the second device, a position of the second device, an orientation of the second device, image data, or a combination thereof.
Clause 17. The apparatus of clause 16, wherein the apparatus comprises the first device or the second device; and wherein the first device comprises a user equipment (UE), the second device comprises a wearable device, and the condition comprises a positional relationship between the UE and the wearable device.
Clause 18. The apparatus of any one of clauses 16-17 wherein the positional relationship comprises a position of the first device relative to the position of the second device, a proximity between the first device and the second device, a co-location of the first device and the second device, an orientation of the first device relative to the orientation of the second device, or a combination thereof.
Clause 19. The apparatus of any one of clauses 16-18 wherein the one or more processors are further configured to determine the position of the first device relative to the position of the second device based on an optical image obtained using the second device, an inertial measurement of the first device, or a combination thereof.
Clause 20. The apparatus of any one of clauses 16-19 wherein the one or more processors are further configured to determine the orientation of the first device relative to the orientation of the second device based on an angle of arrival or an angle of departure of a radio frequency (RF) signal between the first device and the second device.
Clause 21. The apparatus of any one of clauses 16-20 wherein the one or more processors are further configured to determine the proximity between the first device and the second device based on at least one ranging measurement between the first device and the second device.
Clause 22. The apparatus of any one of clauses 16-21 wherein the one or more processors are further configured to determine the co-location of the first device and the second device based on a correlation of one or more inertial measurements of the first device and one or more inertial measurements of the second device.
Clause 23. The apparatus of any one of clauses 16-22 wherein obtaining the one or more measurements indicative of the motion of the first device comprises obtaining one or more first measurements comprising an acceleration measurement, a rotation measurement, or a combination thereof, the one or more first measurements measured using at least one inertial sensor of the first device; obtaining the one or more measurements indicative of the motion of the second device comprises obtaining one or more second measurements comprising an acceleration measurement, a rotation measurement, or a combination thereof, the one or more second measurements measured using at least one inertial sensor of the second device; and the verification of the condition is based on a correlation of one or more first measurements and the one or more second measurements.
Clause 24. The apparatus of any one of clauses 16-23 wherein obtaining the one or more measurements indicative of the motion of the second device comprises receiving the one or more measurements indicative of the motion of the second device from the second device; and receiving the perception information comprises receiving the perception information from the second device.
Clause 25. The apparatus of any one of clauses 16-24 wherein the one or more processors are further configured to perform an application using the received perception information, the application comprising switching from a first wireless communication protocol to a second wireless communication protocol, selecting an access point from a plurality of access points, selecting a beam from a plurality for beams associated with one or more base stations, or performing a position-based operation using the received perception information.
Clause 26. A non-transitory computer-readable apparatus comprising a storage medium, the storage medium comprising a plurality of instructions configured to, when executed by one or more processors, cause the one or more processors to: obtain one or more measurements indicative of a motion or a position of a first device; obtain one or more measurements indicative of a motion or a position of a second device; and receive perception information responsive to a verification that a condition relating to the first device and the second device is established, the verification of the condition being based on the one or more measurements indicative of the motion or the position of the first device and the one or more measurements indicative of the motion or the position of the second device, the perception information comprising a type of environment of the second device, a position of the second device, an orientation of the second device, image data, or a combination thereof.
Clause 27. The non-transitory computer-readable apparatus of clause 26, wherein the condition comprises a positional relationship between the first device and the second device; and the positional relationship comprises a position of the first device relative to the position of the second device, a proximity between the first device and the second device, a co-location of the first device and the second device, an orientation of the first device relative to the orientation of the second device, or a combination thereof.
Clause 28. The non-transitory computer-readable apparatus of any one of clauses 26-27 wherein the plurality of instructions are further configured to, when executed by the one or more processors, cause the one or more processors to: determine the position of the first device relative to the position of the second device based on an optical image obtained using the second device, an inertial measurement of the first device, or a combination thereof; determine the orientation of the first device relative to the orientation of the second device based on an angle of arrival or an angle of departure of a radio frequency (RF) signal between the first device and the second device; determine the proximity between the first device and the second device based on at least one ranging measurement between the first device and the second device; determine the co-location of the first device and the second device based on a correlation of one or more inertial measurements of the first device and one or more inertial measurements of the second device; or a combination thereof.
Clause 29. An apparatus comprising: means for obtaining one or more measurements indicative of a motion or a position of a first device; means for obtaining one or more measurements indicative of a motion or a position of a second device; and means for receiving perception information responsive to a verification that a condition relating to the first device and the second device is established, the verification of the condition being based on the one or more measurements indicative of the motion or the position of the first device and the one or more measurements indicative of the motion or the position of the second device, the perception information comprising a type of environment of the second device, a position of the second device, an orientation of the second device, image data, or a combination thereof.
Clause 30. The apparatus of clause 29, wherein the condition comprises a positional relationship between the first device and the second device; and the positional relationship comprises a position of the first device relative to the position of the second device, a proximity between the first device and the second device, a co-location of the first device and the second device, an orientation of the first device relative to the orientation of the second device, or a combination thereof.

What is claimed is:

1. A method of sharing perception information between a first device and a second device, the method comprising:
obtaining one or more measurements indicative of a motion or a position of the first device;
obtaining one or more measurements indicative of a motion or a position of the second device; and
receiving perception information responsive to a verification that a condition relating to the first device and the second device is established, the verification of the condition being based on the one or more measurements indicative of the motion or the position of the first device and the one or more measurements indicative of the motion or the position of the second device, the perception information comprising a type of environment of the second device, a position of the second device, an orientation of the second device, image data, or a combination thereof.

2. The method of claim 1, wherein the first device comprises a user equipment (UE), the second device comprises a wearable device, and the condition comprises a positional relationship between the UE and the wearable device.

3. The method of claim 2, wherein the wearable device comprises a head-mounted display, a heads-up display, a wrist-worn device, or a finger-worn device.

4. The method of claim 2, the positional relationship comprises a position of the first device relative to the position of the second device, a proximity between the first device and the second device, a co-location of the first device and the second device, an orientation of the first device relative to the orientation of the second device, or a combination thereof.

5. The method of claim 4, further comprising determining the position of the first device relative to the position of the second device based on an optical image obtained using the second device, an inertial measurement of the first device, or a combination thereof.

6. The method of claim 4, further comprising determining the orientation of the first device relative to the orientation of the second device based on an angle of arrival or an angle of departure of a radio frequency (RF) signal between the first device and the second device.

7. The method of claim 4, further comprising determining the proximity between the first device and the second device based on at least one ranging measurement between the first device and the second device.

8. The method of claim 4, further comprising determining the co-location of the first device and the second device based on a correlation of one or more inertial measurements of the first device and one or more inertial measurements of the second device.

9. The method of claim 1, wherein:
obtaining the one or more measurements indicative of the motion of the first device comprises obtaining one or more first measurements comprising an acceleration measurement, a rotation measurement, or a combination thereof, the one or more first measurements measured using at least one inertial sensor of the first device;
obtaining the one or more measurements indicative of the motion of the second device comprises obtaining one or more second measurements comprising an acceleration measurement, a rotation measurement, or a combination thereof, the one or more second measurements measured using at least one inertial sensor of the second device; and
the verification of the condition is based on a correlation of one or more first measurements and the one or more second measurements.

10. The method of claim 1, wherein:
obtaining the one or more measurements indicative of the motion of the second device comprises receiving the one or more measurements indicative of the motion of the second device from the second device; and
receiving the perception information comprises receiving the perception information from the second device.

11. The method of claim 10, further comprising sending a request for the perception information to the second device;
wherein the receiving the perception information is responsive to the request.

12. The method of claim 1, further comprising performing an application using the received perception information, the application comprising switching from a first wireless communication protocol to a second wireless communication protocol, selecting an access point from a plurality of access points, selecting a beam from a plurality for beams associated with one or more base stations, or performing a position-based operation using the received perception information.

13. The method of claim 1, wherein the type of the environment comprises an indoor environment or an outdoor environment, the type of the environment detected using one or more sensors of the second device.

14. The method of claim 1, further comprising:
receiving information about one or more types of perception information that is capable of being shared;
sending a request for at least one of the one or more types of perception information; and
initiating the verification of the condition responsive to a request to initiate the verification of the condition.

15. The method of claim 14, further comprising receiving a user input configured to confirm the initiating of the verification of the condition.

16. An apparatus comprising:
one or more wireless communication interfaces;
one or more sensors;
one or more memory; and
one or more processors coupled to the one or more wireless communication interfaces, the one or more sensors, and the one or more memory, and configured to:
obtain one or more measurements indicative of a motion or a position of a first device;
obtain one or more measurements indicative of a motion or a position of a second device; and
receive perception information responsive to a verification that a condition relating to the first device and the second device is established, the verification of the condition being based on the one or more measurements indicative of the motion or the position of the first device and the one or more measurements indicative of the motion or the position of the second device, the perception information comprising a type of environment of the second device, a position of the second device, an orientation of the second device, image data, or a combination thereof.

17. The apparatus of claim 16, wherein the apparatus comprises the first device or the second device; and
wherein the first device comprises a user equipment (UE), the second device comprises a wearable device, and the condition comprises a positional relationship between the UE and the wearable device.

18. The apparatus of claim 17, wherein the positional relationship comprises a position of the first device relative to the position of the second device, a proximity between the first device and the second device, a co-location of the first device and the second device, an orientation of the first device relative to the orientation of the second device, or a combination thereof.

19. The apparatus of claim 18, wherein the one or more processors are further configured to determine the position of the first device relative to the position of the second device based on an optical image obtained using the second device, an inertial measurement of the first device, or a combination thereof.

20. The apparatus of claim 18, wherein the one or more processors are further configured to determine the orientation of the first device relative to the orientation of the second device based on an angle of arrival or an angle of departure of a radio frequency (RF) signal between the first device and the second device.

21. The apparatus of claim 18, wherein the one or more processors are further configured to determine the proximity between the first device and the second device based on at least one ranging measurement between the first device and the second device.

22. The apparatus of claim 18, wherein the one or more processors are further configured to determine the co-location of the first device and the second device based on a correlation of one or more inertial measurements of the first device and one or more inertial measurements of the second device.

23. The apparatus of claim 16, wherein:
obtaining the one or more measurements indicative of the motion of the first device comprises obtaining one or more first measurements comprising an acceleration measurement, a rotation measurement, or a combination thereof, the one or more first measurements measured using at least one inertial sensor of the first device;
obtaining the one or more measurements indicative of the motion of the second device comprises obtaining one or more second measurements comprising an acceleration measurement, a rotation measurement, or a combination thereof, the one or more second measurements measured using at least one inertial sensor of the second device; and
the verification of the condition is based on a correlation of one or more first measurements and the one or more second measurements.

24. The apparatus of claim 16, wherein:
obtaining the one or more measurements indicative of the motion of the second device comprises receiving the one or more measurements indicative of the motion of the second device from the second device; and
receiving the perception information comprises receiving the perception information from the second device.

25. The apparatus of claim 16, wherein the one or more processors are further configured to perform an application using the received perception information, the application comprising switching from a first wireless communication protocol to a second wireless communication protocol, selecting an access point from a plurality of access points, selecting a beam from a plurality for beams associated with one or more base stations, or performing a position-based operation using the received perception information.

26. A non-transitory computer-readable apparatus comprising a storage medium, the storage medium comprising a plurality of instructions configured to, when executed by one or more processors, cause the one or more processors to:
obtain one or more measurements indicative of a motion or a position of a first device;
obtain one or more measurements indicative of a motion or a position of a second device; and
receive perception information responsive to a verification that a condition relating to the first device and the second device is established, the verification of the condition being based on the one or more measurements indicative of the motion or the position of the first device and the one or more measurements indicative of the motion or the position of the second device, the perception information comprising a type of environment of the second device, a position of the second device, an orientation of the second device, image data, or a combination thereof.

27. The non-transitory computer-readable apparatus of claim 26, wherein
the condition comprises a positional relationship between the first device and the second device; and
the positional relationship comprises a position of the first device relative to the position of the second device, a proximity between the first device and the second device, a co-location of the first device and the second device, an orientation of the first device relative to the orientation of the second device, or a combination thereof.

28. The non-transitory computer-readable apparatus of claim 27, wherein the plurality of instructions are further configured to, when executed by the one or more processors, cause the one or more processors to:
determine the position of the first device relative to the position of the second device based on an optical image obtained using the second device, an inertial measurement of the first device, or a combination thereof;
determine the orientation of the first device relative to the orientation of the second device based on an angle of arrival or an angle of departure of a radio frequency (RF) signal between the first device and the second device;
determine the proximity between the first device and the second device based on at least one ranging measurement between the first device and the second device;
determine the co-location of the first device and the second device based on a correlation of one or more inertial measurements of the first device and one or more inertial measurements of the second device; or
a combination thereof.

29. An apparatus comprising:
means for obtaining one or more measurements indicative of a motion or a position of a first device;
means for obtaining one or more measurements indicative of a motion or a position of a second device; and
means for receiving perception information responsive to a verification that a condition relating to the first device and the second device is established, the verification of the condition being based on the one or more measurements indicative of the motion or the position of the first device and the one or more measurements indicative of the motion or the position of the second device, the perception information comprising a type of environment of the second device, a position of the second device, an orientation of the second device, image data, or a combination thereof.

30. The apparatus of claim 29, wherein
the condition comprises a positional relationship between the first device and the second device; and
the positional relationship comprises a position of the first device relative to the position of the second device, a proximity between the first device and the second device, a co-location of the first device and the second device, an orientation of the first device relative to the orientation of the second device, or a combination thereof.
